(19) United States
(12) Patent Application Publication
(10) Pub. No.: US 2026/0343499 A1
(43) Pub. Date: Oct. 29, 2026

(54) SELECTION OF SPATIAL FILTERS IN REPEATER-ASSISTED NETWORKS

(71) Applicant: TELEFONAKTIEBOLAGET LM ERICSSON (PUBL), STOCKHOLM (SE)

(72) Inventors: Bikramjit Singh, Jorvas (FI); Yufei Blankenship, Kildeer, IL (US)

(21) Appl. No.: 19/102,636

(22) PCT Filed: Aug. 8, 2023
(86) PCT No.: PCT/IB2023/058024

§ 371 Date: Feb. 10, 2025

Related U.S. Application Data
(60) Provisional application No. 63/396,023, filed on Aug. 8, 2022.

(51) Int. Cl. H04W 72/0446; H04W 72/21; H04W 84/04

(52) U.S. Cl. CPC H04W 72/0446; H04W 72/21; H04W 84/047

(57) ABSTRACT

A user equipment (UE) that includes communication circuitry and processing circuitry. The UE is configured such that, if the UE is allocated N transmission opportunities (TOs) in a certain period and the UE transmits data to a base station using only M of the N allocated TOs where M<N, then i) none of the N−M skipped TOs are located between any two TOs that were used to transmit data to the base station or ii) none of the N−M skipped TOs are located between any two TOs that were used to transmit data to the base station unless the skipped TO is or includes an invalid symbol.

### TECHNICAL FIELD

Disclosed are embodiments related to multi-slot transmissions.

### BACKGROUND

Extended reality (referred to as, XR) applications (e.g., virtual reality (VR), augmented reality (AR), mixed reality (MR) applications) and Cloud Gaming (CloudG) applications are currently one of the most important Fifth Generation (5G) applications under consideration in the industry. Below are traffic details for uplink (UL) XR traffic models as stated in 3GPP TR 38.838 V17.0.0 (2021-12):

### Generic UL Pose/Control Traffic

A packet for UL pose/control arrives at UE periodically with following parameters.

| | | Baseline values | |
|---|---|---|---|
| Parameters | unit | for evaluation | Optional value for evaluation |
| Periodicity | ms | 4 | Other values can be optionally |
| | | | evaluated. |
| Jitter | ms | No jitter | |
| Packet size | byte | 100 | |
| PDB | ms | 10 | |
| Packet Success | % | 99 | 90, 95 |
| Rate X | | | |

VR UL and CloudG UL streams follow the generic UL pose and control traffic model. For AR UL traffic, four different options for are provided. Given that AR has multiple streams in UL, one can choose a model from various options depending on what/how to model the streams. The four options are as follows: Model 1 (one stream model); Model 2 (two stream model); Model 3A (three stream model A); and Model 3B (three streams model B).

In Model 1 (one stream model), all AR UL flows are modelled as a single stream with following parameters.

| Parameters | unit | value |
|---|---|---|
| Packet size | byte | Follows clause 5.1.1.1 (i.e., mean packet size = |
| | | R × 1e6/F/8, STD/Min/Max = 10.5/50/150%) |
| packet generation | Hz | 60 |
| rate: F | | |
| Jitter | ms | Optional, follows the description in clause |
| | | 5.1.1.2 |
| Data rate: R | Mbps | 10 (baseline), 20 (optional) |
| PDB | ms | 30 (baseline), 10 or 15 or 60 (optional) |

In Model 2, two streams are considered: 1) Stream 1 for pose/control and 2) Stream 2 aggregating scene, video, data, and audio.

In Model 3A, three steams are considered: 1) Stream 1: pose/control; 2) Stream 2: A stream aggregating streams of scene and video; and 3) Stream 3: A stream aggregating streams of audio and data. The table below shows the statistical parameters for stream 3 of AR UL Model 3A (three streams model).

| Parameters | unit | value |
|---|---|---|
| Data rate: R | Mbps | 0.756, 1.12 |
| Periodicity: P | ms | 10 |
| Packet size | byte | mean packet size = R × 1e6 × P/1000/8 |
| PDB | ms | 30 |

In Model 3B, three streams are considered: 1) Stream 1: pose/control; 2) Stream 2: I-stream for video; and Stream 3: P-stream for video. The table below shows the statistical parameters for stream 2 and 3 of AR UL Model 3B (three streams model).

| | | Baseline values | Optional values for |
|---|---|---|---|
| Parameters | unit | for evaluation | evaluation |
| Packet Success rate | % | 99 | Other values can be |
| X for I stream | | | optionally evaluated. |
| Packet Success rate | % | 99 | Other values can be |
| X for P stream | | | optionally evaluated. |
| PDB for I stream | ms | 30 | Other values can be |
| | | | optionally evaluated. |
| PDB for P stream | ms | 30 | Other values can be |
| | | | optionally evaluated. |

For stream 2 and stream 3, the I/P-stream model for DL video can be reused for UL video.

### SUMMARY

There is an emerging XR use case where UL data packets arrive periodically and the packet sizes can be large. Multi-slot allocation is one technique for handling large UL packet. Multi-slot allocation is the allocation of resources for multiple UL HARQ processes or transport blocks TBs by a single Downlink Control Information (DCI) or in a period of UL Configured Grant (CG). Accordingly, 3GPP is considering supporting multi-slot allocation for pre-configured UL allocation (i.e., configured grant (CG)). At 3GPP meeting #109 there was an agreement “to study whether/how to support a candidate capacity enhancement technique for XR traffic based SPS/CG transmissions,” and stakeholders were encouraged to “Study enhancements related to multiple [Physical Uplink Shared Channels] CG transmission occasions in a period.” (See 3GPP Technical Document (Tdoc) R1-2205268).

Multi-slot allocation is already standardized in 3GPP release 16 (Rel-16) in New Radio UL (NR-U), but only for dynamic allocation. However, in current release 18 (Rel-18) XR SI, the focus is on CG in addition to Dynamic Grant (DG) enhancements.

CG allocation does not behave like DG allocation, and, therefore, the multi-slot framework for CG requires some special treatment and it cannot be assumed that its behavior is similar to DG.

One issue is the “skip uplink” feature, which, by default, is enabled for CG (legacy with single slot allocation). The parameter is denoted “enhancedSkipUplinkTxConfigured-r16”, which is described in 3GPP Technical Specification (TS) 38.321 v17.1.0 (“TS 38.321”) and 3GPP TS 38.331 v17.1.0 (“TS 38.331”). When the “skip uplink” feature is activated, then, for any CG occasion, if there is no data in the buffer, the UE can skip UL transmission, unlike in DG, where the UE may be required to transmit with padding bits (i.e. in DG the UE may not be permitted to skip an UL transmission). Thus, in legacy single slot allocation, the options are: 1) the UE transmits or 2) the UE skips UL (i.e., the UE does not transmit at the allotted occasion).

If, however, instead of allocating to the UE only a single slot per transmission period, the UE is allocated multiple slots per the transmission period (i.e., multi-slot allocation), the skip uplink behavior is currently undefined. For example, the UE could transmit in all of the allocated slots, skip all of the allocated slots, or transmit in some slots and skip others. If the UE takes the third approach (i.e., transmits in some of the allocated slots, but skips the others), then this could have a negative impact on the decoding at the base station (e.g. gNB), such as increasing processing cost and the probability of erroneous reception.

Accordingly, in one aspect there is provided a user equipment (UE). The UE includes communication circuitry and processing circuitry. The UE is configured such that, if the UE is allocated N transmission opportunities (TOs) in a certain period and the UE transmits data to a base station using only M of the N allocated TOs where M<N, then i) none of the N-M skipped TOs are located between any two TOs that were used to transmit data to the base station or ii) none of the N-M skipped TOs are located between any two TOs that were used to transmit data to the base station unless the skipped TO is or includes an invalid symbol.

In another aspect, there is provided a base station. The base station includes communication circuitry and processing circuitry. The base station is configured to allocate to a UE N TOs in a certain period; process uplink control information (UCI) transmitted by the UE, wherein the UCI indicates that during the certain period the UE will use at most M of the N TOs to transmit data to the base station; and send to the UE a retransmission grant for M−E transmissions only, where E is the number of transmission from the UE during the certain period that the base station successfully decoded.

In another aspect, there is provided a method performed by a UE. The method includes obtaining information indicating that the UE is allocated N TOs in a certain period for transmitting data to a base station, where N>1. The method also includes the UE using only M of the N allocated TOs to transmit data to the base station, where M<N, such that i) none of the N−M skipped TOs are located between any two TOs that were used to transmit data to the base station (i.e., the M TOs are consecutive) or ii) none of the N−M skipped TOs are located between any two TOs that were used to transmit data to the base station unless the skipped TO is or includes an invalid symbol.

In another aspect, there is provided a method performed by a base station. The method includes allocating to a UE N TOs in a certain period; receiving uplink control information, UCI, transmitted by the UE, wherein the UCI indicates that during the certain period the UE will use at most M of the N TOs to transmit data to the base station; and sending to the UE a retransmission grant for M−E transmissions only, where E is the number of transmission from the UE during the certain period that the base station successfully decoded.

In another aspect there is provided a computer program comprising instructions which when executed by processing circuitry of an apparatus (a UE or a base station) causes the apparatus to perform any of the methods disclosed herein. In one embodiment, there is provided a carrier containing the computer program wherein the carrier is one of an electronic signal, an optical signal, a radio signal, and a computer readable storage medium. In another aspect there is provided an apparatus that is configured to perform the methods disclosed herein. The apparatus may include memory and processing circuitry coupled to the memory.

An advantage of the embodiments disclosed herein is that they facilitate the reduction of power consumption, processing cost, and decoding errors. Power consumption is reduced to due to no blind decoding requirement which otherwise would have to be employed in order to know whether a transmission is skipped or not (i.e., blind decoding is needed until first actual transmission is detected). Processing cost is reduced because the gNB need not implement detection algorithms which consume processing resources. The error probability decreases because it is less likely for the gNB to concludes that an actual transmission has been skipped.

### BRIEF DESCRIPTION OF THE DRAWINGS

The accompanying drawings, which are incorporated herein and form part of the specification, illustrate various embodiments.

FIG. 1 shows an example of a communication system 100 in accordance with some embodiments.

FIG. 2 shows a UE in accordance with some embodiments.

FIG. 3 shows a network node in accordance with some embodiments.

FIG. 4 shows a host in accordance with some embodiments.

FIG. 5 is a block diagram illustrating a virtualization environment in which functions implemented by some embodiments may be virtualized.

FIG. 6 shows a communication diagram of a host communicating via a network node with a UE over a partially wireless connection in accordance with some embodiments.

FIG. 7 illustrates an example of a multi-TO allocation.

FIG. 8 is a flowchart illustrating a process performed by a UE according to an embodiment.

FIG. 9 is a flowchart illustrating a process performed by a base station according to an embodiment.

### DETAILED DESCRIPTION

### Introduction

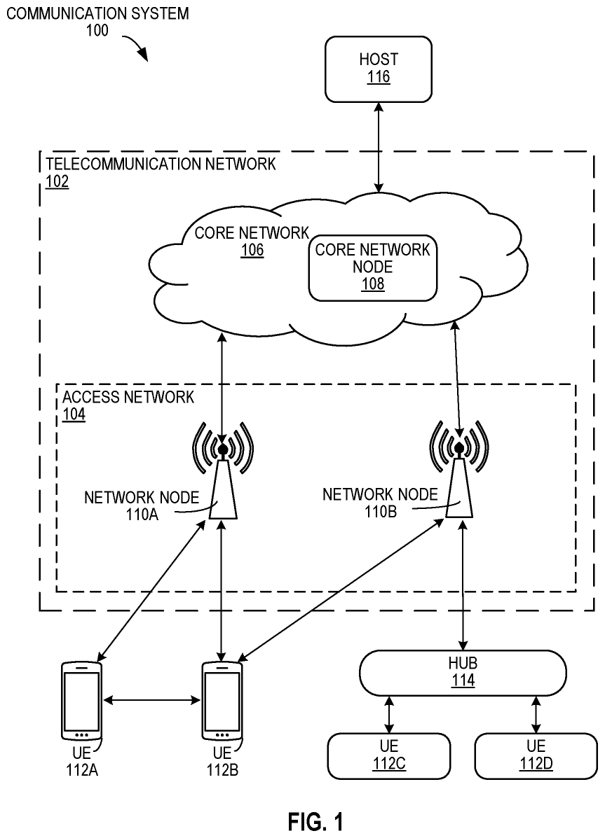

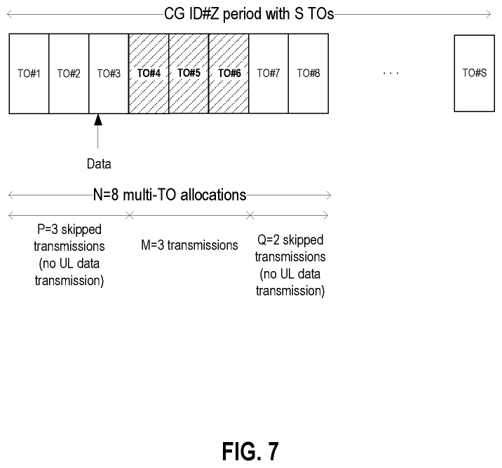

As noted above, if a UE (e.g., UE 112A shown in FIG. 1) is allocated multiple transmission opportunities (e.g., multiple slots, multiple symbols, etc.) per a transmission period (i.e., multi-TO allocation), the UE could potentially transmit in all of the allocated TOs (e.g., slots), skip all of the allocated TOs, or transmit in some TOs and skip others. If the UE takes the third approach (i.e., transmits in some of the allocated TOs, but skips the others), then this could have a negative impact on the decoding at the base station (e.g. gNB), such as increasing processing cost and the probability of erroneous reception. That is, for example, if the UE is allowed to transmit randomly, then this will be tedious for a base station (e.g., base station 110A shown in FIG. 1 (a.k.a., “the gNB”)) to know, for each allocated TO, whether UE has skipped or not, as gNB has to implement some detection rule for each TO. For instance, consider the example shown in FIG. 7, where the UE transmits M=3 transmissions over N=8 allocated TOs in a period consisting of S TOs. If the UE is not constrained with respect when it can skip a transmission, then the gNB must ascertain for every TO, whether the UE skipped the TO.

If, however, the UE is constrained with respect when it can skip a transmission, as described below, and the gNB does not detect the UE's 2^{nd} actual transmission (TO #5), the gNB will send a retransmission grant without implementing any energy detection or propriety rule, etc. This will help to reduce power consumption, processing costs, and decoding errors.

In one particular embodiment, the UE is constrained such that the UE must transmit consecutively in a period so that there is no gap between any two actual transmissions. That is, the UE can skip uplink transmissions over all allocated TOs in the period, before any consecutive transmissions, or after any consecutive transmissions.

In some embodiments, when a UE transmits UL in period with multi-TO allocation (e.g., multi-slot allocation), the UE transmits with a following behavior: the actual transmissions for an UL multi-TO allocation are consecutive except in the cases where the actual transmissions were not allowed due to symbols unavailable for UL data transmission. The UE is allowed to skip the transmissions before the first or after the last transmission in the period. The terminologies first and last transmission is different from the first allocated TO and the last allocated TO. For example, in a CG period, there can be 8 configured TOs (e.g., 8 slots or 8 HARQ processes), however, UE starts its first transmission in the 2^{nd} TO and ends its transmissions in 5^{th} TO (i.e., UE transmits consecutive 4 transmissions).

In some embodiments, there can be configured gap or invalid symbols between allocated TOs where UE is not allowed to transmit during consecutive transmissions.

In some embodiments, if the UE transmits uplink control information (UCI) that indicates specific transmission pattern (which TO allocation from multi-TO is used or skipped), then the actual transmissions must follow the indicated pattern. The UE cannot break the rule where the UCI indicator gives different status than actual transmissions. Otherwise, this can cause confusion at gNB, where gNB may not attempt to decode actual transmissions or attempt to decode skipped transmissions.

### TERMINOLOGY

The term UL multi-TO allocation is used broadly to encompass not only the allocation of multiple slots, but also the allocation of multi-TBs or multi-HARQs or multi-transmissions (e.g. multi-symbols) or multi-PUSCH transmissions per period allocated by, for example, activation DCI or Radio Resource Control (RRC) based signaling. The essence is that a scheduled resource allocation can span over multiple TOs (i.e., time units), where the TO can be a slot (hence multi-slot allocation), a mini-slot, a set of one or more consecutive symbols, a transport block (TB), etc. Hence, the scheduling need not to be purely slot-based. For example, a multi-slot UL allocation over 1.5 slots can be such with sym0 to sym5 for TO1 (e.g., TB #1), sym6 to sym13 for TO2 (e.g., TB #2), and sym 0 to sym 6 in the next slot for TO3.

Some example allocations could be NR UL CG type 1 or 2 with modification, where multi-slot allocation is provided in every period. It can also be extended NR-U CG derived from or based upon Release 16 version.

The embodiments described herein can be applied to licensed, shared, NR-U, NR, Time Division Duplex (TDD), or Frequency Division Duplex (FDD) type of spectrum.

The embodiments described herein are primarily described in the context of NR UL, but this disclosure is not limited to the NR UL scenario. The embodiments can be used with other technologies, e.g., D2D, SL, IAB, Wi-Fi, where one node is transmitter and other node is a receiver.

### Consecutive Actual Transmissions in Multi-TO Allocation

In one use case, a gNB allocates to a UE N TOs (e.g., slots/TB resources/HARQ processes) per period of a single CG (e.g., N=8 as shown in FIG. 7). Hence the UE can transmit M individual UL transmissions (TBs/HARQ processes) consecutively where M=0, . . . , N, and the remaining P and Q allocated TOs can be skipped, where the P allocations can be before the consecutive M transmissions and the Q allocations can be after the consecutive M transmissions, such that P+Q=N−M (See FIG. 7).

The UE can skip P transmissions due to late arrival of payload data, 0<=P<=N. That is, referring to FIG. 7, it is possible that the payload data is not available for the UE to transmit until TO #4. When P=0, no upfront individual transmissions are skipped, i.e., the UE starts the multi-TO allocation as scheduled without skipping. When P=N (and M=0, Q=0), all individual transmissions in the multi-TO allocation are skipped, i.e., the entire multi-TO allocation is skipped without any UL transmission.

The UE can skip Q transmissions due to no more data in the UE's buffer (0<=Q<=N). In the example shown in FIG. 7, the UE only has payload data for 3 TOs (TO #4, TO #5, TO #6), and no data is available for transmission for TO #7 and TO #8. When Q=0, the UE continues the UL transmission till the end of the scheduled multi-TO allocation. When Q=N (and M=0, P=0), this is equivalent to P=N (and M=0, Q=0), i.e., all individual transmissions in the multi-TO allocation are skipped (i.e., the entire multi-TO allocation is skipped without any UL transmission).

In one embodiment, if the UE receives a retransmission grant for any skipped TO, the UE can ignore the grant.

In one embodiment, if a UE skips UL transmissions over the first P UL TOs, then the UE is not allowed to transmit on any of remaining TO, i.e., over the remaining N−P TOs, where P={1, . . . N−1}. Network can configure the parameter P based on gNB's blind decode requirement. If P is set large, gNB will have higher blind decode cost. It means, on non-transmitted resources (slots) belonging to set P, i.e., for first P UL allocations, network tries to detect the transmission, which will increase power use and the processing resources.

### Uplink Control Information (UCI)

In one embodiment, when a UCI is sent by the UE to the gNB to indicate skipped TOs, the UE will not transmit data on those skipped TOs indicated by the sent UCI.

As an example, assume N=8 multi-TO allocation (i.e., 8 TOs are allocated to the UE) and the UE decides to transmit in the first 6 TOs and skip the last two. With this assumption the UE will transmit to the gNB UCI indicating that the last two TOs will be skipped in the CG period. However, after the UCI is sent but before the end of the CG period, more data arrives in the UE's transmit buffer. Even though UE has empty resources (in the form of last 2 supposedly skipped TO), the UE must not utilize the last TOs for the newly arrived data, because the gNB will read the UCI and therefore likely to skip decoding of last two transmissions.

In one embodiment, if the UE has sent UCI indicating skipped TOs where the UCI was multiplexed onto one or more of the UL transmissions in the current multi-TO allocation, then if new data arrives in the current period, the new data must be transmitted in next period, thus cannot be transmitted over supposedly skipped transmission resources in the current period.

In one embodiment, the UCI is sent or included in transmissions to indicate Q skipped TOs (e.g., the TOs that come after the continuous set of one or more TOs used to transmit data), the UE may not indicate initial P skipped TOs (e.g., the TOs that come after the continuous set of one or more TOs used to transmit data), as they occur before the first actual transmission.

In one embodiment, the UCI is sent or included in transmissions to indicate initial P skipped transmissions. The reason to indicate initial P skipped transmissions so that gNB does not send to the UE any retransmission request for those skipped initial P transmissions.

In one embodiment, the UCI is sent in first actual transmission from M consecutive transmissions. Based on example presented in FIG. 7, the UCI will be during TO #4.

In one embodiment, the UCI is sent in all actual transmissions (in all M consecutive transmissions). Based on example presented in FIG. 7, the UCI will be sent in TO #4, TO #5, and TO #6.

In one embodiment, if a UE indicated Q skipped transmissions or both P and Q skipped transmissions from multi-TO allocations with N TOs allocated, and UE has transmitted M transmissions, such that P+M+Q=N; where if network has decoded E number of transmissions, such that E<M, and the network has decoded the value P, Q (i.e., UCI is successfully decoded), then network will send retransmission grant of M-E transmissions only.

### Unavailable (“Invalid”) TOs

In some embodiments, from the M TOs that are planned to be used by the UE to transmit data to the gNB, K number of TOs (K≤M) can be skipped if the resources of the skipped TOs are “invalid” for UL transmissions. For example, the resources are part of a pre-defined resource for DL transmission, the resources are part of idle period of FFP for NR-U operation under FBE mode, or the resources are preempted by the network with preemption indicator using DCI 2_1. The gNB knows that over these K transmissions, UE cannot transmit, thus, gNB will not attempt to decode them.

Hence, the UL transmissions of a scheduled multi-TO transmission may be interrupted due to symbols unavailable for UL transmission. Such interruption may occur regardless of the presence or absence of skipping of any individual TO in the UL multi-slot allocation. The symbols unavailable for UL transmission are referred to as “invalid symbols.”

In one embodiment, the UE determines the invalid symbol(s) for the scheduled UL multi-TO transmission as follows:
(1) A symbol that is indicated as downlink by tdd-UL-DL-ConfigurationCommon or tdd-UL-DL-ConfigurationDedicated is considered as an invalid symbol for UL multi-TO transmission;
(2) For operation in unpaired spectrum, symbols indicated by ssb-PositionsInBurst in SIB1 or ssb-PositionsInBurst in ServingCellConfigCommon for reception of SS/PBCH blocks are considered as invalid symbols for UL multi-TO transmission;
(3) For a reduced capability half-duplex UE in paired spectrum and for UL multi-TO transmission, symbols indicated by ssb-PositionsInBurst in SIB1 or ssb-PositionsInBurst in ServingCellConfigCommon for reception of SS/PBCH blocks are considered as invalid symbols for UL multi-TO transmission;
(4) For operation in unpaired spectrum, symbol(s) indicated by pdcch-ConfigSIBI in MIB for a CORESET for Type0-PDCCH CSS set are considered as invalid symbol(s) for UL multi-TO transmission;
(5) For operation in unpaired spectrum, if numberOfInvalidSymbolsForDL-UL-Switching is configured, numberOfInvalidSymbolsForDL-UL-Switching symbol(s) after the last symbol that is indicated as downlink in each consecutive set of all symbols that are indicated as downlink by tdd-UL-DL-ConfigurationCommon or tdd-UL-DL-ConfigurationDedicated are considered as invalid symbol(s) for UL multi-TO transmission (the symbol(s) given by numberOfInvalidSymbolsForDL-UL-Switching are defined using the reference SCS configuration referenceSubcarrierSpacing provided in tdd-UL-DL-ConfigurationCommon);
(6) For operation with shared spectrum channel access with semi-static channel occupancy, symbols in an idle duration associated with a periodic channel occupancy as described in section 4.3.1.1 of 3GPP TS 37.213 v17.2.0 (“TS 37.213”), or in an idle duration in a period associated with an initiated channel occupancy as described in section 4.3.2. of TS 37.213 are considered as invalid symbol(s) for UL multi-TO transmission;
(7) The UE may be configured with the higher layer parameter invalidSymbolPattern, which provides a symbol level bitmap spanning one or two slots (higher layer parameter symbols given by invalidSymbolPattern); a bit value equal to 1 in the symbol level bitmap symbols indicates that the corresponding symbol is an invalid symbol for UL multi-TO transmission. The UE may be additionally configured with a time-domain pattern (higher layer parameter periodicityAndPattern given by invalidSymbolPattern), where each bit of periodicityAndPattern corresponds to a unit equal to a duration of the symbol level bitmap symbols, and a bit value equal to 1 indicates that the symbol level bitmap symbols is present in the unit. The periodicityAndPattern can be {1, 2, 4, 5, 8, 10, 20 or 40} units long, but maximum of 40 msec. The first symbol of periodicityAndPattern every 40 msec/P periods is a first symbol in frame nf mod 4=0, where P is the duration of periodicityAndPattern-r16 in units of msec. When periodicityAndPattern is not configured, for a symbol level bitmap spanning two slots, the bits of the first and second slots correspond respectively to even and odd slots of a radio frame, and for a symbol level bitmap spanning one slot, the bits of the slot correspond to every slot of a radio frame. If invalidSymbolPattern is configured, when the UE applies the invalid symbol pattern is determined as follows:

| | |
|---|---|
| - | if the PUSCH is scheduled by DCI format 0_1, or corresponds to a Type 2 |
| | configured grant activated by DCI format 0_1, and if |
| | invalidSymbolPatternIndicatorDCI-0-1 is configured, |

| | |
|---|---|
| - | if invalid symbol pattern indicator field is set 1, the UE applies the invalid symbol |
| | pattern; |
| - | otherwise, the UE does not apply the invalid symbol pattern; |

| | |
|---|---|
| - | if the PUSCH is scheduled by DCI format 0_2, or corresponds to a Type 2 |
| | configured grant activated by DCI format 0_2, and if |
| | invalidSymbolPatternIndicatorDCI-0-2 is configured, |

| | |
|---|---|
| - | if invalid symbol pattern indicator field is set 1, the UE applies the invalid symbol |
| | pattern; |
| - | otherwise, the UE does not apply the invalid symbol pattern; |

| | - | otherwise, the UE applies the invalid symbol pattern. |
|---|---|---|
| - | If the UE | |
| | - | is configured with multiple serving cells within a cell group and is provided with |
| | | directionalCollisionHandling-r16 = ‘enabled’ for a set of serving cell(s) among the |
| | | multiple serving cells, and |
| | - | indicates support of half-DuplexTDD-CA-SameSCS-r16 capability, and |
| | - | is not configured to monitor PDCCH for detection of DCI format 2-0 on any of the |
| | | multiple serving cells, |

| | |
|---|---|
| - | a symbol indicated to the UE for reception of SS/PBCH blocks in a first cell of the |
| | multiple serving cells by ssb-PositionsInBurst in SIB1 or ssb-PositionsInBurst in |
| | ServingCellConfigCommon is considered as an invalid symbol for UL multi-slot |
| | transmission in |

| | |
|---|---|
| - | any of the multiple serving cells if the UE is not capable of simultaneous |
| | transmission and reception as indicated by simultaneousRxTxInterBandCA |
| | among the multiple serving cells, and |
| - | any one of the cells corresponding to the same band as the first cell, |
| | irrespective of any capability indicated by simultaneousRxTxInterBandCA |

| and | |
|---|---|
| - | a symbol is considered as an invalid symbol in another cell among the set of |
| | serving cell(s) provided with directionalCollisionHandling-r16 for UL multi-slot |
| | transmission with Type 1 or Type 2 configured grant except for the first Type 2 |
| | PUSCH transmission (including all repetitions) after activation if the symbol is |
| | indicated as downlink by tdd-UL-DL-ConfigurationCommon or tdd-UL-DL- |
| | ConfigurationDedicated on the reference cell as defined in Clause 11.1 of TS |
| | 38.213, or the UE is configured by higher layers to receive PDCCH, PDSCH, or |
| | CSI-RS on the reference cell in the symbol. |

When actual transmission j within the UL multi-TO allocation overlaps with any symbols unavailable for UL data transmission (i.e., “invalid symbols”), there can be two options to handle the actual transmission j.
Option 1: the actual transmission j is cancelled due to the unavailable UL symbols. Thus given the intended actual UL transmission of { . . . , j−1, j, j+1, . . . }, the final actual UL transmission is: { . . . , j−1, <NONE>, j+1, . . . }, where <NONE> indicates that actual transmission j is cancelled due to the unavailable UL symbols, while actual transmission j+1 proceed as scheduled without being affected.
Option 2: the actual transmission j and all subsequent transmissions (if any), i.e., {j, j+1, j+2 . . . }, are delayed due to the unavailable UL symbols. Thus given the intended actual UL transmission of { . . . j−1, j, j+1, . . . }, the final actual UL transmission is: { . . . , j−1, <unavailable symbols>, j, j+1, . . . }, where <unavailable symbols> indicate that space was made for the symbols unavailable for UL transmission. The actual transmissions {j, j+1, . . . } are delayed without cancellation/dropping.

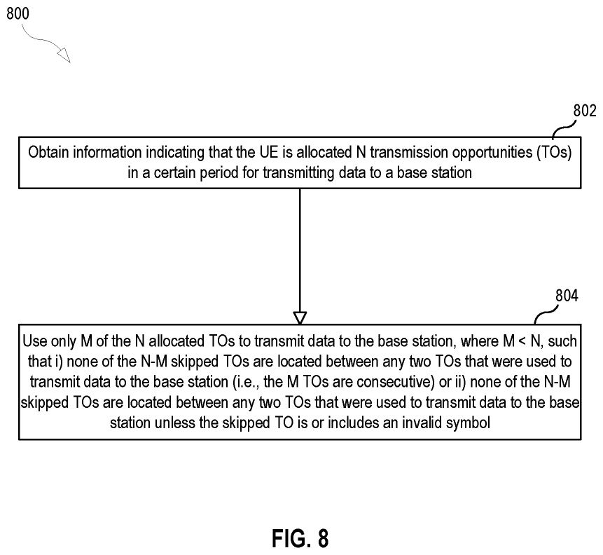

FIG. 8 is a flow chart illustrating a process 800 performed by a user equipment (i.e., UE 112A), according to an embodiment, for transmitting data from UE 112A to gNB 110A. Process 500 may begin in operation 802. Operation 802 comprises obtaining information indicating that the UE is allocated N TOs in a certain period for transmitting data to base station 110A, where N>1. Operation 804 comprises the UE using only M of the N allocated TOs to transmit data to the base station, where M<N, such that i) none of the N−M skipped TOs are located between any two TOs that were used to transmit data to the base station (i.e., the M TOs are consecutive) or ii) none of the N−M skipped TOs are located between any two TOs that were used to transmit data to the base station unless the skipped TO is or includes an invalid symbol.

In some embodiments, the method further comprises transmitting to the base station uplink control information (UCI) indicating the N−M skipped TOs.

In some embodiments, the UE transmits the UCI to the base station by transmitting the UCI during at least one of the M TOs.

In some embodiments, the UCI does not indicate any TO that precedes said TO that was used to transmit the UCI.

In some embodiments, the UCI indicates that at least one of the N−M skipped TOs precedes said TO that was used to transmit the UCI.

In some embodiments, the UCI is only transmitted in the first one of the M TOs.

In some embodiments, the UCI is transmitted in the each of the M TOs.

In some embodiments, the method further comprises receiving a retransmission grant corresponding to one or more of the N−M skipped TOs; and ignoring the retransmission grant.

In some embodiments, each of the allocated N TOs is a slot comprising a plurality of symbols.

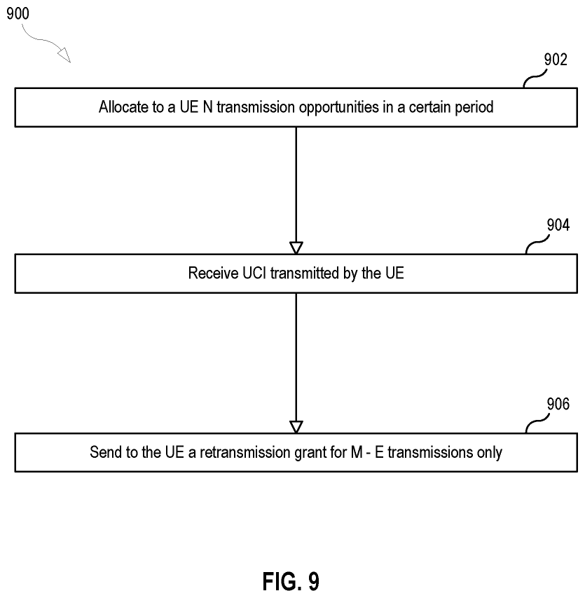

FIG. 9 is a flow chart illustrating a process 900 performed by base station 110A, according to an embodiment. Process 900 may begin in operation 902. Operation 902 comprises allocating to a UE (i.e., UE 112A) N TOs in a certain period. Operation 904 comprises receiving UCI transmitted by the UE, wherein the UCI indicates that during the certain period the UE will use at most M of the N TOs to transmit data to the base station. Operation 906 comprises sending to the UE a retransmission grant for M−E transmissions only, where E is the number of transmissions from the UE during the certain period that the base station successfully decoded.

In some embodiments, each of the allocated N TOs is a slot comprising a plurality of symbols.

FIG. 1 shows an example of a communication system 100 in accordance with some embodiments.

In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b (one or more of which may be generally referred to as network nodes 110), or any other similar 3^{rd} Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 102 includes one or more Open-RAN (ORAN) network nodes. An ORAN network node is a node in the telecommunication network 102 that supports an ORAN specification (e.g., a specification published by the O-RAN Alliance, or any similar organization) and may operate alone or together with other nodes to implement one or more functionalities of any node in the telecommunication network 102, including one or more network nodes 110 and/or core network nodes 108.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 110 facilitate direct or indirect connection of user equipment (UE), such as by connecting UEs 112a, 112b, 112c, and 112d (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of FIG. 1 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular if one or more of the UEs are low energy IoT devices.

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110b. In other embodiments, the hub 114 may be a non-dedicated hub—that is, a device which is capable of operating to route communications between the UEs and network node 110b, but which is additionally capable of operating as a communication start and/or end point for certain data channels.

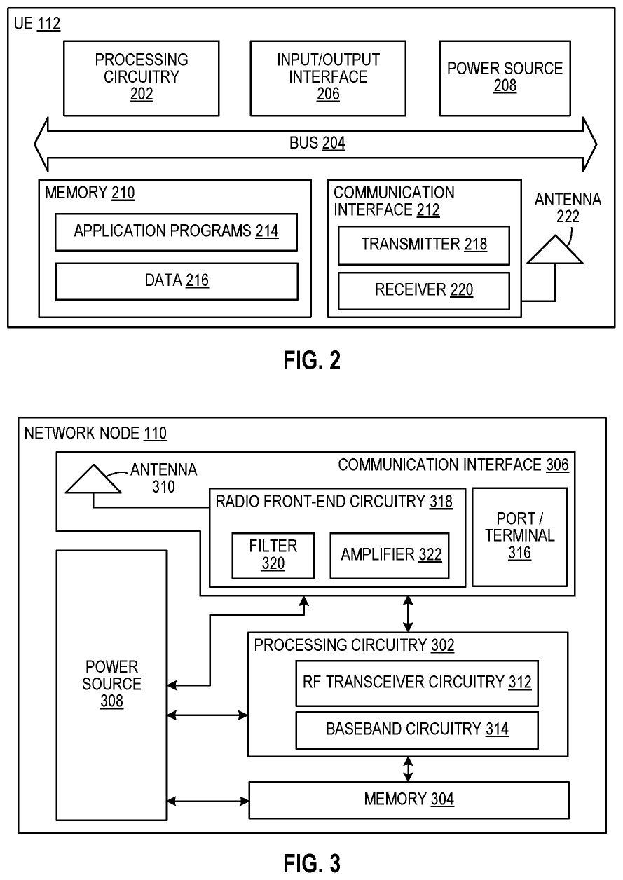

FIG. 2 shows a UE 112 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 112 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 2. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 112. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 112 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 112 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 112, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 112 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 112 shown in FIG. 2.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 3 shows a network node 110 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 110 includes a processing circuitry 302, a memory 304, a communication interface 306, and a power source 308. The network node 110 may be composed of multiple physically separate components (e.g., a NodeB component and a RNC component, or a BTS component and a BSC component, etc.), which may each have their own respective components. In certain scenarios in which the network node 110 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 110 may be configured to support multiple radio access technologies (RATs). In such embodiments, some components may be duplicated (e.g., separate memory 304 for different RATs) and some components may be reused (e.g., a same antenna 310 may be shared by different RATs). The network node 110 may also include multiple sets of the various illustrated components for different wireless technologies integrated into network node 110, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 110.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 110 components, such as the memory 304, to provide network node 110 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 110. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 110 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 110 and connectable to the network node 110 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 110 in a form suitable for the respective components (e.g., at a voltage and current level needed for each respective component). The power source 308 may further comprise, or be coupled to, power management circuitry to supply the components of the network node 110 with power for performing the functionality described herein. For example, the network node 110 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 110 may include additional components beyond those shown in FIG. 3 for providing certain aspects of the network node's functionality, including any of the functionality described herein and/or any functionality necessary to support the subject matter described herein. For example, the network node 110 may include user interface equipment to allow input of information into the network node 110 and to allow output of information from the network node 110. This may allow a user to perform diagnostic, maintenance, repair, and other administrative functions for the network node 110.

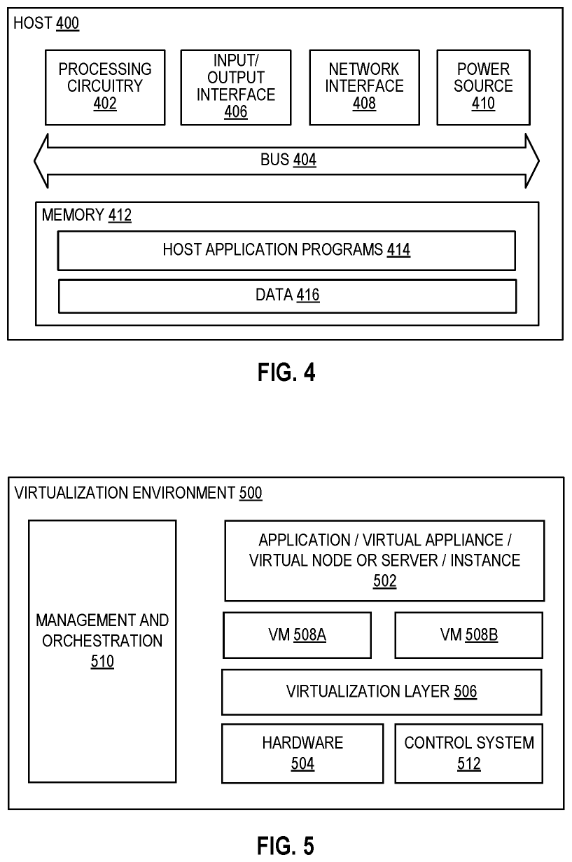

FIG. 4 is a block diagram of a host 400, which may be an embodiment of the host 116 of FIG. 1, in accordance with various aspects described herein. As used herein, the host 400 may be or comprise various combinations hardware and/or software, including a standalone server, a blade server, a cloud-implemented server, a distributed server, a virtual machine, container, or processing resources in a server farm. The host 400 may provide one or more services to one or more UEs.

The host 400 includes processing circuitry 402 that is operatively coupled via a bus 404 to an input/output interface 406, a network interface 408, a power source 410, and a memory 412. Other components may be included in other embodiments. Features of these components may be substantially similar to those described with respect to the devices of previous figures, such as FIGS. 2 and 3, such that the descriptions thereof are generally applicable to the corresponding components of host 400.

The memory 412 may include one or more computer programs including one or more host application programs 414 and data 416, which may include user data, e.g., data generated by a UE for the host 400 or data generated by the host 400 for a UE. Embodiments of the host 400 may utilize only a subset or all of the components shown. The host application programs 414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 414 may also provide for user authentication and licensing checks and may periodically report health, routes, and content availability to a central node, such as a device in or on the edge of a core network. Accordingly, the host 400 may select and/or indicate a different host for over-the-top services for a UE. The host application programs 414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 5 is a block diagram illustrating a virtualization environment 500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 500 includes components defined by the O-RAN Alliance, such as an O-Cloud environment orchestrated by a Service Management and Orchestration Framework via an O-2 interface.

Applications 502 (which may alternatively be called software instances, virtual appliances, network functions, virtual nodes, virtual network functions, etc.) are run in the virtualization environment 400 to implement some of the features, functions, and/or benefits of some of the embodiments disclosed herein.

Hardware 504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 506 (also referred to as hypervisors or virtual machine monitors (VMMs)), provide VMs 508a and 508b (one or more of which may be generally referred to as VMs 508), and/or perform any of the functions, features and/or benefits described in relation with some embodiments described herein. The virtualization layer 506 may present a virtual operating platform that appears like networking hardware to the VMs 508.

The VMs 508 comprise virtual processing, virtual memory, virtual networking or interface and virtual storage, and may be run by a corresponding virtualization layer 506. Different embodiments of the instance of a virtual appliance 502 may be implemented on one or more of VMs 508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 508 may be a software implementation of a physical machine that runs programs as if they were executing on a physical, non-virtualized machine. Each of the VMs 508, and that part of hardware 504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 508 on top of the hardware 504 and corresponds to the application 502.

Hardware 504 may be implemented in a standalone network node with generic or specific components. Hardware 504 may implement some functions via virtualization. Alternatively, hardware 504 may be part of a larger cluster of hardware (e.g. such as in a data center or CPE) where many hardware nodes work together and are managed via management and orchestration 510, which, among others, oversees lifecycle management of applications 502. In some embodiments, hardware 504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 512 which may alternatively be used for communication between hardware nodes and radio units.

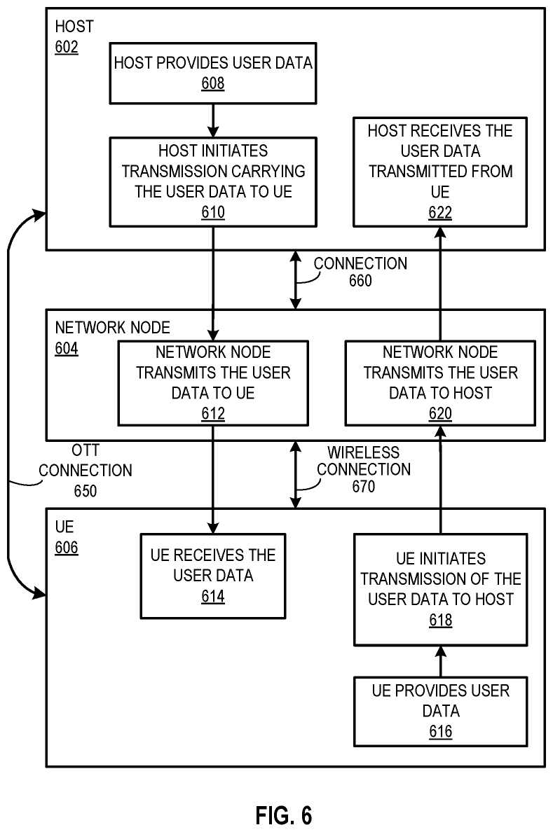

FIG. 6 shows a communication diagram of a host 602 communicating via a network node 604 with a UE 606 over a partially wireless connection in accordance with some embodiments. Example implementations, in accordance with various embodiments, of the UE (such as a UE 112a of FIG. 1), network node (such as network node 110a of FIG. 1), and host (such as host 116 of FIG. 1 and/or host 400 of FIG. 4) discussed in the preceding paragraphs will now be described with reference to FIG. 6.

Like host 400, embodiments of host 602 include hardware, such as a communication interface, processing circuitry, and memory. The host 602 also includes software, which is stored in or accessible by the host 602 and executable by the processing circuitry. The software includes a host application that may be operable to provide a service to a remote user, such as the UE 606 connecting via an over-the-top (OTT) connection 650 extending between the UE 606 and host 602. In providing the service to the remote user, a host application may provide user data which is transmitted using the OTT connection 650.

The network node 604 includes hardware enabling it to communicate with the host 602 and UE 606. The connection 660 may be direct or pass through a core network (like core network 106 of FIG. 1) and/or one or more other intermediate networks, such as one or more public, private, or hosted networks. For example, an intermediate network may be a backbone network or the Internet.

The UE 606 includes hardware and software, which is stored in or accessible by UE 606 and executable by the UE's processing circuitry. The software includes a client application, such as a web browser or operator-specific “app” that may be operable to provide a service to a human or non-human user via UE 606 with the support of the host 602. In the host 602, an executing host application may communicate with the executing client application via the OTT connection 650 terminating at the UE 606 and host 602. In providing the service to the user, the UE's client application may receive request data from the host's host application and provide user data in response to the request data. The OTT connection 650 may transfer both the request data and the user data. The UE's client application may interact with the user to generate the user data that it provides to the host application through the OTT connection 650.

The OTT connection 650 may extend via a connection 660 between the host 602 and the network node 604 and via a wireless connection 670 between the network node 604 and the UE 606 to provide the connection between the host 602 and the UE 606. The connection 660 and wireless connection 670, over which the OTT connection 650 may be provided, have been drawn abstractly to illustrate the communication between the host 602 and the UE 606 via the network node 604, without explicit reference to any intermediary devices and the precise routing of messages via these devices.

As an example of transmitting data via the OTT connection 650, in operation 608, the host 602 provides user data, which may be performed by executing a host application. In some embodiments, the user data is associated with a particular human user interacting with the UE 606. In other embodiments, the user data is associated with a UE 606 that shares data with the host 602 without explicit human interaction. In operation 610, the host 602 initiates a transmission carrying the user data towards the UE 606. The host 602 may initiate the transmission responsive to a request transmitted by the UE 606. The request may be caused by human interaction with the UE 606 or by operation of the client application executing on the UE 606. The transmission may pass via the network node 604, in accordance with the teachings of the embodiments described throughout this disclosure. Accordingly, in operation 612, the network node 604 transmits to the UE 606 the user data that was carried in the transmission that the host 602 initiated, in accordance with the teachings of the embodiments described throughout this disclosure. In operation 614, the UE 606 receives the user data carried in the transmission, which may be performed by a client application executed on the UE 606 associated with the host application executed by the host 602.

In some examples, the UE 606 executes a client application which provides user data to the host 602. The user data may be provided in reaction or response to the data received from the host 602. Accordingly, in operation 616, the UE 606 may provide user data, which may be performed by executing the client application. In providing the user data, the client application may further consider user input received from the user via an input/output interface of the UE 606. Regardless of the specific manner in which the user data was provided, the UE 606 initiates, in operation 618, transmission of the user data towards the host 602 via the network node 604. In operation 620, in accordance with the teachings of the embodiments described throughout this disclosure, the network node 604 receives user data from the UE 606 and initiates transmission of the received user data towards the host 602. In operation 622, the host 602 receives the user data carried in the transmission initiated by the UE 606.

One or more of the various embodiments improve the performance of OTT services provided to the UE 606 using the OTT connection 650, in which the wireless connection 670 forms the last segment. More precisely, the teachings of these embodiments may reduce the power consumption, processing cost, and decoding errors and thereby provide benefits such as extended battery lifetime and better responsiveness.

In an example scenario, factory status information may be collected and analyzed by the host 602. As another example, the host 602 may process audio and video data which may have been retrieved from a UE for use in creating maps. As another example, the host 602 may collect and analyze real-time data to assist in controlling vehicle congestion (e.g., controlling traffic lights). As another example, the host 602 may store surveillance video uploaded by a UE. As another example, the host 602 may store or control access to media content such as video, audio, VR or AR which it can broadcast, multicast or unicast to UEs. As other examples, the host 602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 650 between the host 602 and UE 606, in response to variations in the measurement results. The measurement procedure and/or the network functionality for reconfiguring the OTT connection may be implemented in software and hardware of the host 602 and/or UE 606. In some embodiments, sensors (not shown) may be deployed in or in association with other devices through which the OTT connection 650 passes; the sensors may participate in the measurement procedure by supplying values of the monitored quantities exemplified above, or supplying values of other physical quantities from which software may compute or estimate the monitored quantities. The reconfiguring of the OTT connection 650 may include message format, retransmission settings, preferred routing etc.; the reconfiguring need not directly alter the operation of the network node 604. Such procedures and functionalities may be known and practiced in the art. In certain embodiments, measurements may involve proprietary UE signaling that facilitates measurements of throughput, propagation times, latency and the like, by the host 602. The measurements may be implemented in that software causes messages to be transmitted, in particular empty or ‘dummy’ messages, using the OTT connection 650 while monitoring propagation times, errors, etc.

### Summary of Various Embodiments

1. A user equipment (e.g., UE 112), the user equipment comprising: communication circuitry; and processing circuitry, wherein the UE is configured such that, if the UE is allocated N transmission opportunities, TOs, in a certain period and the UE transmits data to a base station (e.g., BS 110) using only M of the N allocated TOs where M<N, then i) none of the N−M skipped TOs are located between any two TOs that were used to transmit data to the base station (i.e., the M TOs are consecutive) or ii) none of the N−M skipped TOs are located between any two TOs that were used to transmit data to the base station unless the skipped TO is or includes an invalid symbol.
2. The UE of embodiment 1, wherein the UE is further configured to transmit to the base station uplink control information, UCI, indicating the N−M skipped TOs.
3. The UE of embodiment 2, wherein the UE is configured to transmit the UCI to the base station by transmitting the UCI during at least one of the M TOs.
4. The UE of embodiment 3, wherein the UE is configured such that the UCI will not indicate any TO that precedes said TO that was used to transmit the UCI.
5. The UE of embodiment 3, wherein the UE is configured such that the UCI indicates that at least one of the N−M skipped TOs precedes said TO that was used to transmit the UCI.
6. The UE of embodiment 3, wherein the UE is configured such that the UCI is only transmitted in the first one of the M TOs.
7. The UE of embodiment 3, wherein the UE is configured such that the UCI is transmitted in the each of the M TOs.
8. The UE of any one of embodiments 1-7, wherein the UE is configured such that, if the UE receives a retransmission grant corresponding to any one or more of the N−M skipped TOs, then the UE ignores the retransmission grant.
9.1 The UE of any one of embodiments 1-8, wherein each of the allocated N TOs is a slot comprising a plurality of symbols.
9.1 The UE of any one of embodiments 1-8, wherein UE is extended reality device.
10. A base station (e.g., BS 110), the base station comprising: communication circuitry; and processing circuitry, wherein the base station is configured to: allocate to UE 112, N transmission opportunities, TOs, in a certain period; process uplink control information, UCI, transmitted by the UE, wherein the UCI indicates that during the certain period the UE will use at most M of the N TOs to transmit data to the base station; and send to the UE a retransmission grant for M−E transmissions only, where E is the number of transmission from the UE during the certain period that the base station successfully decoded.
11. The base station of embodiment 10, wherein each of the allocated N TOs is a slot comprising a plurality of symbols.
12. A method performed by a UE (e.g., UE 112), the method comprising: obtaining information indicating that the UE is allocated N transmission opportunities, TOs, in a certain period for transmitting data to a base station (e.g., BS 110), where N>1; using only M of the N allocated TOs to transmit data to the base station, where M<N, such that i) none of the N−M skipped TOs are located between any two TOs that were used to transmit data to the base station (i.e., the M TOs are consecutive) or ii) none of the N−M skipped TOs are located between any two TOs that were used to transmit data to the base station unless the skipped TO is or includes an invalid symbol.
13. The method of embodiment 12, further comprising transmitting to the base station uplink control information, UCI, indicating the N−M skipped TOs.
14. The method of embodiment 13, wherein the UE transmits the UCI to the base station by transmitting the UCI during at least one of the M TOs.
15. The method of embodiment 14, wherein the UCI does not indicate any TO that precedes said TO that was used to transmit the UCI.
16. The method of embodiment 14, wherein the UCI indicates that at least one of the N−M skipped TOs precedes said TO that was used to transmit the UCI.
17. The method of embodiment 14, wherein the UCI is only transmitted in the first one of the M TOs.
18. The method of embodiment 14, wherein the UCI is transmitted in the each of the M TOs.
19. The method of any one of embodiments 12-18, further comprising: receiving a retransmission grant corresponding to one or more of the N−M skipped TOs; and ignoring the retransmission grant.
20. The method of any one of embodiments 12-19, wherein each of the allocated N TOs is a slot comprising a plurality of symbols.
21. A method (900) performed by base station 110, the method comprising: allocating to UE 112, N transmission opportunities, TOs, in a certain period; receiving uplink control information, UCI, transmitted by the UE, wherein the UCI indicates that during the certain period the UE will use at most M of the N TOs to transmit data to the base station; and sending to the UE a retransmission grant for M−E transmissions only, where E is the number of transmission from the UE during the certain period that the base station successfully decoded.
22. The method of embodiment 21, wherein each of the allocated N TOs is a slot comprising a plurality of symbols.
23. The method of any embodiment, wherein the certain period consists of a single configured grant (CG) period, or the certain period comprises two or more CG periods.
24. A computer program comprising instructions which when executed by processing circuitry of UE 112 causes the UE to perform the method of any one of embodiments 12-20.
25. A carrier containing the computer program of embodiment 24, wherein the carrier is one of an electronic signal, an optical signal, a radio signal, and a computer readable storage medium.
26. A computer program comprising instructions which when executed by processing circuitry 302 of base station 110 causes the base station to perform the method of any one of embodiments 21-23.
27. A carrier containing the computer program of embodiment 26, wherein the carrier is one of an electronic signal, an optical signal, a radio signal, and a computer readable storage medium 304.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

As used herein transmitting a message “to” or “toward” an intended recipient encompasses transmitting the message directly to the intended recipient or transmitting the message indirectly to the intended recipient (i.e., one or more other nodes are used to relay the message from the source node to the intended recipient). Likewise, as used herein receiving a message “from” a sender encompasses receiving the message directly from the sender or indirectly from the sender (i.e., one or more nodes are used to relay the message from the sender to the receiving node). Further, as used herein “a” means “at least one” or “one or more.”

Additionally, while the processes described above and illustrated in the drawings are shown as a sequence of operations, this was done solely for the sake of illustration. Accordingly, it is contemplated that some operations may be added, some operations may be omitted, the order of the operations may be re-arranged, and some operations may be performed in parallel.

1. A user equipment, the user equipment (UE) comprising:
communication circuitry; and
processing circuitry, wherein
the UE is configured such that, if the UE is allocated N transmission opportunities, TOs, in a certain period and the UE transmits data to a base station using only M of the N allocated TOs where M<N, then i) none of the N−M skipped TOs are located between any two TOs that were used to transmit data to the base station or ii) none of the N−M skipped TOs are located between any two TOs that were used to transmit data to the base station unless the skipped TO is or includes an invalid symbol.

2. The UE of claim 1, wherein the UE is further configured to transmit to the base station uplink control information (UCI) indicating the N−M skipped TOs.

3. The UE of claim 2, wherein the UE is configured to transmit the UCI to the base station by transmitting the UCI during at least one of the M TOs.

4. The UE of claim 3, wherein the UE is configured such that the UCI will not indicate any TO that precedes said TO that was used to transmit the UCI.

5. The UE of claim 3, wherein the UE is configured such that the UCI indicates that at least one of the N−M skipped TOs precedes said TO that was used to transmit the UCI.

6. The UE of claim 3, wherein the UE is configured such that the UCI is only transmitted in the first one of the M TOs.

7. The UE of claim 3, wherein the UE is configured such that the UCI is transmitted in the each of the M TOs.

8. The UE of claim 1, wherein the UE is configured such that, if the UE receives a retransmission grant corresponding to any one or more of the N−M skipped TOs, then the UE ignores the retransmission grant.

9. The UE of claim 1, wherein each of the allocated N TOs is a slot comprising a plurality of symbols.

10. The UE of claim 1, wherein UE is an extended reality device.

11. A base station, the base station comprising:
communication circuitry; and
processing circuitry, wherein
the base station is configured to:
allocate to a user equipment (UE), N transmission opportunities TOs in a certain period;
process uplink control information (UCI) transmitted by the UE, wherein the UCI indicates that during the certain period the UE will use at most M of the N TOs to transmit data to the base station; and
send to the UE a retransmission grant for M−E transmissions only, where E is the number of transmission from the UE during the certain period that the base station successfully decoded.

12. The base station of claim 11, wherein each of the allocated N TOs is a slot comprising a plurality of symbols.

13. A method performed by a user equipment, the method comprising:
obtaining information indicating that the UE is allocated N transmission opportunities (TOs) in a certain period for transmitting data to a base station, where N>1;
using only M of the N allocated TOs to transmit data to the base station, where M<N, such that i) none of the N−M skipped TOs are located between any two TOs that were used to transmit data to the base station or ii) none of the N−M skipped TOs are located between any two TOs that were used to transmit data to the base station unless the skipped TO is or includes an invalid symbol.

14. The method of claim 13, further comprising transmitting to the base station uplink control information (UCI) indicating the N−M skipped TOs.

15. The method of claim 14, wherein the UE transmits the UCI to the base station by transmitting the UCI during at least one of the M TOs.

16. The method of claim 15, wherein the UCI does not indicate any TO that precedes said TO that was used to transmit the UCI.

17. The method of claim 15, wherein the UCI indicates that at least one of the N−M skipped TOs precedes said TO that was used to transmit the UCI.

18. The method of claim 15, wherein the UCI is only transmitted in the first one of the M TOs.

19. The method of claim 15, wherein the UCI is transmitted in the each of the M TOs.

20. The method of claim 13, further comprising:
receiving a retransmission grant corresponding to one or more of the N−M skipped TOs; and
ignoring the retransmission grant.

21. The method of claim 13, wherein each of the allocated N TOs is a slot comprising a plurality of symbols.

22. A method performed by a base station, the method comprising:
allocating to a user equipment (UE), N transmission opportunities (TOs) in a certain period;
receiving uplink control information (UCI) transmitted by the UE, wherein the UCI indicates that during the certain period the UE will use at most M of the N TOs to transmit data to the base station; and
sending to the UE a retransmission grant for M−E transmissions only, where E is the number of transmission from the UE during the certain period that the base station successfully decoded.

23. (canceled)

24. (canceled)

25. (canceled)

26. (canceled)

27. (canceled)

28. (canceled)
